(19) United States
(12) Patent Application Publication
(10) Pub. No.: US 2014/0303839 A1
(43) Pub. Date: Oct. 9, 2014

(54) USAGE PREDICTION FOR CONTEXTUAL INTERFACE

(71) Applicant: Ford Global Technologies, LLC, Dearborn, MI (US)

(72) Inventors: Dimitar Petrov FILEV, Novi, MI (US); Jeffrey Allen GREENBERG, Ann Arbor, MI (US); Ryan Abraham MCGEE, Shanghai (CN); Johannes Geir KRISTINSSON, Ann Arbor, MI (US); Fling TSENG, Ann Arbor, MI (US)

(73) Assignee: Ford Global Technologies, LLC, Dearborn, MI (US)

(21) Appl. No.: 14/249,931

(22) Filed: Apr. 10, 2014

Related U.S. Application Data
(63) Continuation-in-part of application No. 13/855,973, filed on Apr. 3, 2013.

(51) Int. Cl. G08G 1/0967

(52) U.S. Cl. CPC G08G 1/096716
USPC 701/36

(57) ABSTRACT

A vehicle interface system may include an interface configured to present icons representing selectable vehicle features; and a controller programmed to generate a score for each of the features based on a contextual variable including one or all of a vehicle location, vehicle speed, past feature usage information, and a predicted end location for the vehicle, and display certain of the icons and hide other of the icons based on the generated scores.

### CROSS-REFERENCE TO RELATED APPLICATIONS

This application is a continuation-in-part of U.S. application Ser. No. 13/855,973 filed Apr. 3, 2013, now pending, the disclosure of which is hereby incorporated in its entirety by reference herein.

### TECHNICAL FIELD

The present disclosure relates to usage prediction for a contextual interface.

### BACKGROUND

A conventional vehicle includes many systems that allow a vehicle user to interact with the vehicle. In particular, conventional vehicles provide a variety of devices and techniques to control and monitor the vehicle's various subsystems and functions. As technology is advancing, more and more features are being introduced to control various subsystems within the vehicle. Some of these features may be presented to the user via a user interface. However, these features may be presented in a fixed manner to the user. Thus, there is a need for an enhanced and flexible system for presenting vehicle features to the user.

### SUMMARY

A vehicle interface system may include an interface configured to present icons representing selectable vehicle features; and a controller programmed to generate a score for each of the features based on a contextual variable including one or all of a vehicle location, vehicle speed and a predicted end location for the vehicle, and display certain of the icons and hide other of the icons based on the generated scores.

A vehicle controller may include at least one contextual module configured to generate at least one contextual variable representing a driving context including vehicle location or vehicle speed, and a processor programmed to generate a feature score based on one or both of a vehicle location and vehicle speed as defined by the at least one contextual variable, wherein the feature score representing the likelihood that the vehicle feature will be selected based on the driving context, and display certain of the icon and hide other of the icons based on the feature scores.

A method may include receiving at least one contextual variable from a contextual module, generating a feature score based on the at least one contextual variable, and displaying an icon associated with a vehicle feature, based on the feature score to an interface device, the icon configured to interact with a system associated with the corresponding vehicle feature.

### BRIEF DESCRIPTION OF THE DRAWINGS

FIG. 1A illustrates exemplary components of the user interface system;

FIG. 1B is a block diagram of exemplary components in the user interface system of FIG. 1A;

FIG. 2 illustrates a flowchart of an exemplary process that may be implemented by the user interface system;

FIG. 3 illustrates a block diagram of a possible implementation of the user interface system of FIG. 1A;

FIG. 4 illustrates a flowchart of a possible implementation that may be performed by the user interface system of FIG. 3;

FIG. 5 illustrates a flowchart of an alternative implementation that may be performed by the user interface system of FIG. 3;

FIG. 6 illustrates an exemplary location database which may be utilized by the user interface system of FIG. 1A;

FIG. 7A illustrates a chart of exemplary score indicating the likelihood to stop output by the exemplary components of the user interface system of FIG. 1A;

FIG. 7B illustrates a chart of exemplary score indicating the likelihood to stop output by the exemplary components of the user interface system of FIG. 1A;

FIG. 8 illustrates an exemplary block diagram for generating a feature score;

FIGS. 9A-C are exemplary data charts indicative of contextual variables for generating a feature score; and

FIG. 10 illustrates an exemplary flowchart for generating a feature score.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicle interface systems may provide various options for accessing and interacting with vehicle systems to the user. These systems may include climate control systems, navigation systems, parking systems, etc. Each system may enable various vehicle features, such as cruise control, driving directions, parking assistance, etc. At certain times while the vehicle is in use, certain ones of these features may be more likely to be relevant to the current driving conditions than others. For example, while the vehicle is driving at high speeds, it may be more likely that the driver may use the cruise control feature and less likely that the driver would use a parking feature. For another example, when vehicle is driving below 20 miles per hour, it may be impossible to engage the cruise control feature. In that case, the impossibility of using that feature may result in it being hidden from the driver. Based on the driving context, a vehicle interface system may use this inferred probability to promote certain features to be displayed on user interface within the vehicle. That is, certain icons associated with the vehicle features may be displayed or hidden based on the likelihood that they would be selected for use by the user. Thus, the user may easily view and select relevant features. Features that are unlikely or impossible to be used may not be displayed so as to not overwhelm the driver with unnecessary options while driving. In the example of the parking feature (e.g., Park Assist, back-up cameras), certain variables may be used to develop a feature score. For example, the distance between the current location and the destination may be used to determine how likely the driver is to use a parking feature. Additionally, the number of times the feature has been selected previously by the driver at the destination, as well as the current speed of the vehicle, may also be used to determine a feature score and promote the parking feature at the user interface accordingly. In addition, the current status of the feature may be observed. If the feature is already in use, there is no need to promote that feature.

A vehicle system may have a controller configured to receive a sensor input. The controller may generate a feature score based at least in part on the sensor input and a location data within a database. The controller may associate the feature score to a selectable option. The controller may instruct a user interface device to display the selectable option in response to the feature score, thus allowing the user to view options that may be of interest based on several attributes such as the sensor input and location data. In one example, the selectable options may include a park assist option and/or a valet option. The park assist option, when selected, may automatically assist drivers in parking their vehicles. That is, the vehicle can steer itself into a parking space, whether parallel or perpendicular parking, with little to no input from the user. In another example, a valet option may be available. The valet mode may be activated near specific locations having valet services, such as hotels, restaurants, bars, etc. Thus, the exemplary system may detect when a vehicle is approaching an establishment where a user may wish to take advantage of either the park assist or valet options. These options may gain preference over other vehicle features, such as cruise control, and be presented to the user via the user interface device. The valet mode may blackout of dim the display screens within the vehicle so that personal information and preferences may not be accessible to the driver performing the valet service. The valet mode feature is generally equipped within a system that has navigation systems and infotainment systems. Such information, such as the vehicle owner's home address, would not be available to a unauthorized drivers.

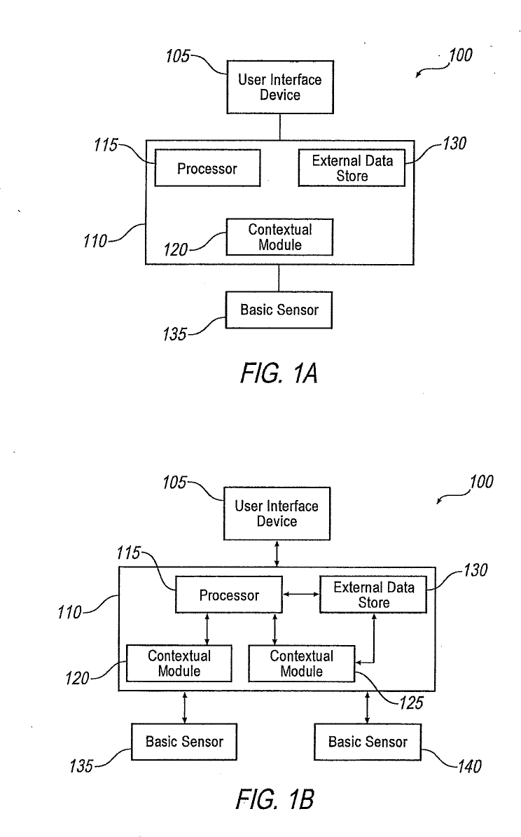

FIG. 1A illustrates an exemplary user interface system. The system may take many different forms and include multiple and/or alternate components and facilities. While an exemplary system is shown in the Figures, the exemplary components illustrated in the Figures are not intended to be limiting. Indeed, additional or alternative components and/or implementations may be used.

FIG. 1A illustrates a diagram of the user interface system 100. While the present embodiment may be used in an automobile, the user interface system 100 may also be used in any vehicle including, but not limited to, motorbikes, boats, planes, helicopters, off-road vehicles, cargo trucks, etc.

With reference to FIGS. 1A and 1B, the system 100 includes a user interface device 105. The user interface device 105 may include a single interface, for example, a single-touch screen, or multiple interfaces. The user interface system 100 may additionally include a single type interface or multiple interface types (e.g., audio and visual) configured for human-machine interaction. The interface device 105 may include a display such as a touch screen. It may also include a display controlled by various hardware control elements. The interface device 105 may also include a heads-up-display (HUD) unit in which images are projected onto the windshield of the vehicle. The user interface device 105 may be configured to receive user inputs from the vehicle occupants. The user interface device may include, for example, control buttons and/or control buttons displayed on a touchscreen display (e.g., hard buttons and/or soft buttons) which enable the user to enter commands and information for use by the user interface system 100. Inputs provided to the user interface device 105 may be passed to the controller 110 to control various aspects of the vehicle. For example, inputs provided to the user interface device 105 may be used by the controller 110 to monitor the climate in the vehicle, interact with a navigation system, control media playback, use park assist, or the like. The user interface device 105 may also include a microphone that enables the user to enter commands or other information vocally.

In communication with the user interface device 105 is a controller 110. The controller 110 may include any computing device configured to execute computer-readable instructions that controls the user interface device 105 as discussed herein. For example, the controller 110 may include a processor 115, a contextual module 120, and an external data store 130. The external data store 130 may be comprised of a flash memory, RAM, EPROM, EEPROM, hard disk drive, or any other memory type or combination thereof. Alternatively, the contextual module 120 and the external data store 130 may be incorporated into the processor. In yet another embodiment, there may be multiple control units in communication with one another, each containing a processor 115, contextual module 120, and external data store 130. The controller 110 may be integrated with, or separate from, the user interface device 105.

In general, computing systems and/or devices, such as the controller 110 and the user interface device 105 may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating system distributed by Apple, Inc. of Cupertino, Calif., the Blackberry OS distributed by Research in Motion of Waterloo, Canada, and the Android operating system developed by the Open Handset Alliance. It will be apparent to those skilled in the art from the disclosure that the precise hardware and software of the user interface device 105 and the controller 110 can be any combination sufficient to carry out the functions of the embodiments discussed herein.

The controller 110 may be configured to control the availability of a feature on the user interface device 105 through the processor 115. The processor 115 may be configured to detect a user input indicating the user's desire to activate a vehicle system or subsystem by detecting the selection of a selectable option on the user interface device 105. A selectable option is created for each feature available in the vehicle (e.g., temperature control, heated seats, parking assists, cruise control, etc.). Each selectable option may control a vehicle system or subsystem. For example, the selectable option for cruise control will control the vehicle system monitoring the vehicle's constant speed (or cruise control). Further each selectable option may control more than one vehicle system. For example, a user may select a selectable option pertaining to a driver assist technology. This selection may control a park assist feature, as well as enable certain rear view cameras to be activated. The selectable option may include an icon for being displayed on the interface. It may also include a textual description of the vehicle feature that the respective option controls, among other visual representations.

The controller 110, via the processor 115, may be configured to determine the features most likely to be of use to the driver or passenger, and eliminate the features that have minimal or no use to the driver/passenger, given the particular driving context. In order to determine the feature that may have the most relevance at the moment, the controller 110 may receive input from a plurality of contextual variables communicated by the contextual module 120 and the basic sensor 135 via an interface (not shown). The interfaces may include an input/output system configured to transmit and receive data from the respective components. The interface may be one-directional such that data may only be transmitted in one direction. Additionally, the interface may be bi-directional, both receiving and transmitting data between the components.

The controller may include many contextual modules 120, each configured to output a specific context or contextual variable. For example, one contextual module 120 may be configured to determine the distance to a known location. Another contextual module 120 may be configured to determine the vehicle's speed in relation to the current speed limit. Yet another contextual module may be configured to determine whether the vehicle has entered a new jurisdiction requiring different driving laws (e.g., a “hands-free” driving zone). In another example, a contextual module may be configured to access a data store 130 to determine how often a certain vehicle feature is used at a certain location. In another exemplary illustration, each output may be received by each of the many selectable options, and may be used and reused by the selectable options to produce a feature score. That is, each of the many contextual modules 120 always performs the same operation. For example, the contextual module 120 for vehicle's speed in relation to current speed limit will always output that context, although the context may be received by different selectable options. A contextual variable may also use vehicle and vehicle module specific information to output a contextual score. For example, the parking assist feature may not be functional/selectable unless the vehicles speed as below 10 miles per hour. In this context, the output contextual score also encode a vehicle subsystem's design and or physical limits in which it operable and available to the driver/passenger.

A contextual variable may represent a particular driving condition, for example, the vehicle's speed or a previous location in which the driver activated a feature. The contextual variables may be output from the contextual module 120 or the basic sensor 135. The controller 110 may be configured to select a feature with a high likelihood of vehicle user interaction based on the input received from the contextual module 120 and basic sensors 135. For example, the controller 110 may indicate that the feature for cruise control may be of particular relevance due to the driving context or circumstance. In one exemplary approach, each feature available on the user interface device 105 is represented by one particular selectable option. For example, the feature for a garage door opener may be always associated with a selectable option for the garage door opener.

The contextual variables may be a numerical value depending on the driving context. In one possible implementation, the contextual variables range from a value of 0 to 1, with 1 representing the strongest value. Additionally or alternatively, the contextual variables may represent a particular context, such as outside temperature, precipitation, or distance to a specific establishment or destination. For example, the contextual variable output may indicate the vehicle is approaching an establishment that offers valet services. The output may indicate the vehicle is approaching a parking structure, parking lot, or street parking location. There may be two types of contextual variables: simple contextual variables and smart contextual variables. Simple contextual variables may be derived from the basic sensor 135. A basic sensor 135 may include any sensor or sensor systems available on the vehicle. For example, the basic sensor 135 could embody audio sensors, light sensors, accelerometers, velocity sensors, temperature sensors, navigation sensors (such as a Global Positioning System sensor), etc. Smart contextual variables may be output by the contextual module 120 and may represent other contextual variables aggregated into values which are not readily available in the vehicle. That is, no other system or subsystem within the vehicle can generate a smart contextual variable alone. For example, in order to produce the smart contextual variables, the contextual module 120 may receive inputs from either simple contextual variables output by the basic sensors 135 or other smart contextual variables output by contextual modules 120 and aggregate these outputs into complex values (e.g., aggregations of multiple values). There may be various ways in which the contextual module may produce their values. For example, techniques may involve simple or advanced algebraic calculations, Fuzzy Logic, Neural Networks, Statistics, Frequentist Inference, etc.

The controller 110 may include location data saved in a database, such as an external data store 130. The external data store 130 may be located within the controller 110 or as a separate component. The location data may include stop location data, for example, the previous stop locations of the vehicle, or selectable option data which may include, for example, the number of times a selectable option has been activated at a previous stop location (e.g., location-based feature usage). For a parking location, public domain information such as fee/free and or parking rates where applicable may be available. The location data may also include point of interest data, for example, valet points-of-interest which indicate locations that provide valet services (e.g., restaurants, hotels, conference halls, etc.). Point-of-interest data may additionally include the user's preference for a given situation, for example, a crowded establishment versus a secluded establishment. For example, the user may set his or her preference for restaurants that offer valet services which may influence the feature score attributed to each selectable option. While the data store 130 may be included in the controller 110, it may also be located remotely of the controller 110 and may be in communication with the controller 110 through a network, such as, for example, cloud computing resources or API's (Application Programming Interface) over the Internet.

The processor 115 may be configured to communicate with the external data store 130 whenever saved information is needed to assist in generating a selectable option. The external data store 130 may communicate with the contextual module 125 to produce a smart contextual variable Likewise, the external data store 130 may communicate directly with the processor 115. The external data store 130 may be composed of general information such as a navigation database which may, for example, retain street and jurisdiction specific laws, or user specific information such as the preferred inside temperature of the vehicle. Additionally or alternatively, the external data store 130 may track vehicle feature activations at specific locations or under particular driving conditions. For example, the external data store may save the number of cruise control activations on a specific highway. This may, in turn, effect the feature score for cruise control when the vehicle is driving on that highway. Further, the external data store 130 may be updated using, for example, telematics or by any other suitable technique. A telematics system located within the vehicle may be configured to receive updates from a server or other suitable source (e.g., vehicle dealership) Likewise, the external data store 130 may be updated manually with input from the vehicle user provided to the user interface device 105. Furthermore, the controller 110 may be configured to enable the user interface system 100 to communicate with a mobile device through a wireless network. Such a network may include a wireless telephone, Bluetooth®, personal data assistant, 3G and 4G broadband devices, etc.

In an exemplary illustration, the user interface device 105 may permit a user to specify certain preferences with respect to a location. A user may set a preference for locations providing valet services or offering a secluded dining environment. These preferences may be saved in the external data store 130 (e.g., as a point of interest) and may be utilized by the contextual module 120, 125 to affect the contextual variable output. For example, the feature score for valet mode at a particular establishment may be weighted higher (e.g., produce a higher feature score), if the user sets his/her preference to include valet mode, regardless of whether the user has previously stopped at that establishment. Thus, it may not be necessary to have previously stopped at a particular location in order to generate a high feature score if the user's preferences are customized in a certain manner.

The processor 115 may be configured to detect inputs, such as the contextual variables, communicated by the contextual module 120. The processor 115 may store each selectable option associated with a specific feature available for use by the user interface device 105. Each selectable option takes input from a range of contextual variables generated from a basic sensor 135 and the contextual module 120. The processor 115 aggregates the variables received to generate a feature score associated with the selectable options which indicates the likelihood the particular feature will be interacted with by the user. Thus, each selectable option is associated with a feature score. However, depending on the driving conditions and context, the feature scores associated with the selectable options may differ. Many implementations may be used to aggregate the contextual variables, such as, but not limited to, taking the product, summation, average, or non-linear algorithms such as fuzzy logic, for example. In one embodiment, the processor 115 may associate a decimal feature score of 0 to 1 with the selectable option, in which 0 may represent the feature is unlikely to be selected at the moment and 1 represents that the user has the highest likelihood of wanting to use the feature. Thus, a feature already in use (e.g., the vehicle system or subsystem is currently in use) would score low on the decimal system because there is no likelihood of future interaction with the feature. However, this choice may be altered by the driver or manufacture so that 1 represents that the user is actively interacting with the feature. Further, the decimal score range is illustrative only and a different range of numbers could be used if desired.

After the processor 115 generates a feature score, the processor 115 may promote the feature score to the user interface device 105. Based on the preference of the driver or manufacturer, the processor 115 may select the selectable option with the highest feature score to display on the user interface device 105. The highest feature score may be representative of the preferred selectable option or feature being selected. That is, the selectable option associated with the highest feature score may be the preferred feature. In an alternative embodiment, the processor 115 may rank the selectable options based on their feature scores and select multiple features with the highest feature scores to be displayed on the user interface device 105. Selectable options associated with lower scores may be hidden, or removed from user interface device 105. The icons displayed via the user interface device 105 may continually change as the feature scores associated with each change.

In a specific example, a parking feature, such as an Active Park Assist for parallel parking, or a general parking feature using rear-view camera views for perpendicular parking, may be available to the vehicle. Parking features may likely be used at certain locations, certain geographical areas (e.g., a city, downtown, near a popular venue, etc.), at certain times of day, etc. Furthermore, parking features may be more likely to be used when the vehicle is traveling at a low speed. In this exemplary illustration, a basic sensor (e.g. basic sensor 135) may output the current location of the vehicle (by way of GPS, for example). Another basic sensor (e.g., basic sensor 140) may output the speed of the vehicle. Both of these outputs may be simple contextual variables. The simple contextual variable speed and location may be received at the contextual module 120. The contextual module 120 may use the current location to gather additional smart contextual variables. In one example, the current location may be used to determine possible end locations (e.g., the desired destination). These end locations may be entered by the user using the navigation system. They may also be learned or predicted locations. The predicted end locations may be compared with the current location. The end location closest to the current location may be selected and evaluated. The contextual module 120, 125 may use the end location to look up the type of the features previously selected by the user when at the end location. That is, at the end location, has the user used a parking feature previously. Additionally, the contextual module 120, 125 may receive these contextual variables as well as other variables. In one example, the contextual module 120, 125 may receive public parking data indicating parking option near the current location. These variables may be transmitted to the processor 115 which may assign a feature score for each selectable option relative to the particular driving context. In one example, if the vehicle is close to a location that the vehicle typically uses a parking feature, but is traveling at a high speed, a low score (e.g., 0.3) may be given to the driving context. In another example, if the vehicle is traveling at a lower speed, a higher score (e.g., 0.8) may be given to the driving context. The processor 115 may select the selectable option(s) with the highest score to display on the user interface device 105. The selectable option may replace current options when the feature score associated with the selectable option exceeds the feature score of the currently displayed options.

With respect to the above example, the system 100 may use a current vehicle location, and end location, and a vehicle speed to determine a feature score for a parking feature. The end location may be a user's desired destination. The end location may be determined by the contextual module 120, 125. It may also be determined by another component (e.g., the GPS system) in response to user input. As discussed, the end location may also be a predicted destination or location. The predicted destination may be determined based on a dynamic learning and prediction module. The module may be capable of learning and recoding various stop and start habits and frequency locations may be recognized inherently without user input. The prediction module may take into account several factors such as time of day, day of the week, etc. Thus, when the vehicle begins driving along a recognized route, the module may predict that the end location is one of a handful of likely destinations based on the past history of the user and/or vehicle. Further, the predicted location may be a location that the user has previously used a parking feature at. These historical parking locations may be identified by a user indicated within the data store 130 as described herein.

The end location may also be used to determine a potential external parking location. The external parking location may differ from the end location in that the parking location may be a parking structure or lot near the end location. The external parking locations may be obtained from the data store 130 or other location such as from a mobile device via a wireless communication or dedicated channel. For example, a map application within a mobile device may provide nearby parking structures to the processor 115 and/or contextual module 120, 125. A local municipality map providing various parking locations may also be used. Data store 130 may also include a map database of available parking locations. Thus, the external parking locations may be provided by data store 130, or another component in or outside of the interface system 100. In some situation, the external parking locations may come from a public source, as well as a private database.

FIG. 1B illustrates a general system interaction of an embodiment of the user interface system 100. Initially, the controller receives input from basic sensors 135 and 140 which collect information from sensors or sensor systems available on the vehicle and output simple contextual variables. For example, the basic sensor could represent the current outside temperature, a vehicle speed sensor, or vehicle GPS location. The contextual modules 120 and 125 may receive simple contextual variables, other smart contextual variables, and/or location data from the external data store 130 to produce smart contextual variables. Location data from the external data store 130 may include parking locations received from a public source, as well as a private database. The processor 115 may receive both the smart contextual variables and simple contextual variables to ascribe their values to multiple selectable options. The selectable options are each associated with a feature score that is generated from the values of the contextual variable received. Every selectable option receives input from the basic sensors and contextual modules continuously. However, depending on the driving context, the feature scores associated with the selectable options differ. For example, if the contextual variables communicate that the vehicle is driving on a highway close to the speed limit, the selectable option for the feature cruise control will produce a high score, whereas the feature for heated seats or garage door opener will produce a low feature score.

The processor 115 may rank the selectable options according to their feature score. The processor 115 may select the highest scoring selectable option. Depending on how the user interface system 100 is configured, the processor 115 may either promote the selectable option with the highest feature score or promote multiple selectable options to the user interface device 105. At the same time, the processor 115 may eliminate a feature(s) from the user interface device 105 that no longer has a high likelihood of user interaction. The basic sensors 135, 140, and contextual modules 120, 125 are active at all times to facilitate the production of a continuous feature score for each selectable option. The processor 115 uses these scores to provide the most current driving contexts to the user interface device 105 so that the selectable option with the highest feature score is always displayed on the user interface device 105.

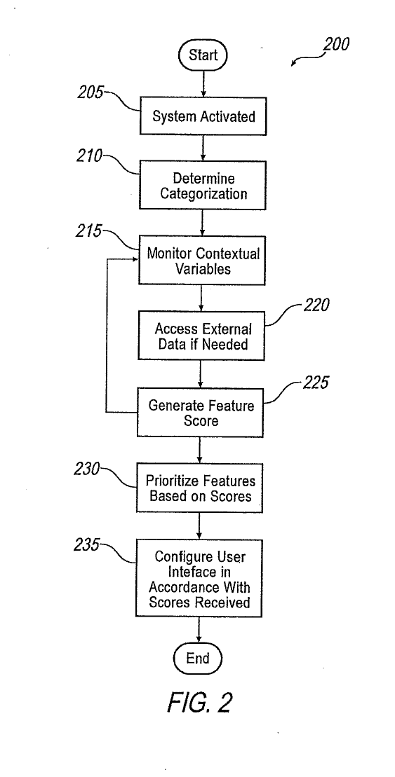

FIG. 2 illustrates a flowchart of an exemplary process 200 that may be implemented by the user interface system 100. The operation of the user interface system 100 may activate (block 205) automatically no later than when the vehicle's ignition is started. At this point, the vehicle may go through an internal system check in which the operational status of one or more vehicle systems and/or subsystems will be determined in order to ensure that the vehicle is ready for operation. While the internal system check is being verified, the system 100 may additionally determine the categorization of the selectable options available in the vehicle at block 210. The system 100 may additionally categorize the available features (and their corresponding selectable options) of the user interface system 100 into a departure group and an arrival group. The departure category may include features commonly used when leaving a location, for example, a garage door opener or climate control. The arrival category may include features commonly used when in route to or arriving at a destination, for example, cruise control or parking assistance. The categorization process may be performed by the controller 110. The separation of features may either be preset by the vehicle manufacturer or dealership, or the vehicle owner may customize the departure group and arrival group based on their preference. Separating the features into two or more groups may help reduce processing time in the later stages by limiting the number of features available for selection.

At block 215, the system 100 may begin monitoring the contextual variables produced by the basic sensors 135 and the contextual modules 120. As previously mentioned, the contextual variables may be either simple contextual variables which are derived directly from sensors available in the vehicle, or smart contextual variables derived from aggregations of other contextual variables (whether simple or smart) into values not readily available in the vehicle. The system 100 may further check whether additional external information is needed at block 220 from the external data store 130. This may occur where the contextual variables require stored information, such as street speed limits, location data, or cabin temperature preference of the vehicle user. If additional external information is need, the information may be communicated to the contextual modules 120 to generate a smart contextual variable. If additional external information is not needed, or has already been provided and no more information is required, the process 200 may continue at block 225.

At block 225, the contextual variables may be communicated to the processor 115 to generate a feature score. The processor 115 may aggregate the inputs (e.g., the contextual variables) received and associate the values to each selectable option to produce the feature score. The feature scores may be generated by aggregating the contextual variables by taking the product, average, maximum, minimum, etc., or any combination or variation, or any non-linear algorithm, such as fuzzy logic. The feature score may be directly proportional to the relevance of the aggregation of the contextual variables communicated to the processor 115. For example, when the contextual variables indicate that a vehicle is driving on a highway, has a relative speed close to the speed limit, but notices the vehicle is varying speeds above and below the speed limit (e.g., as in the case of heavy traffic), the feature score for the cruise control selectable option will have a lesser value compared to when the vehicle is traveling at a constant speed, near the speed limit, for a period of time. Furthermore, the same variables attributed to the parking assist selectable option, for example, will have a very low feature score because the likelihood of engage a parking feature while traveling at high speeds is very low.

At block 230, the processor 115 may prioritize the selectable options based on their associated feature scores. Generally, the selectable options with the highest feature score may have the highest priority, and the rest of the available selectable options are ranked accordingly thereon. Depending on the user preference, either the feature with the highest feature score, or multiple features (e.g., the three features with the highest feature score), may be promoted to the user interface device 105 at block 235 for display and performance. Likewise, the features already displayed on the user interface device 105 may be simultaneously eliminated (or demoted) if their relevance within the particular driving context has decreased. Additionally or alternatively, the processor 115 or controller 110 may order the selectable options according to the feature score associated with each selectable option. The controller 110 may then determine the order of the selectable options with feature scores above a predetermined threshold. For example, the controller 110 may only select the selectable options with a feature score at or above 0.7. The controller 110 may then rank the available selectable options with the highest feature score to a first position in the order, and another selectable option with a slightly lower feature score to a second position in the order, and so on.

As shown, blocks 215 to 225 perform a continuous cycle while the vehicle is in operation. The basic sensors 135 and contextual modules 120 are active at all times, continually inputting information into the processor which continuously generates new feature scores. Accordingly, the processor 115 updates the priority rankings at block 230 so the most relevant features will be presented at all times on the user interface device 105 at block 235.

In at least one embodiment of the disclosure, the user interface system 100 may determine a selectable option based on received sensor inputs and location data. The location data may include previous stop locations and location-based feature usage. The selectable option may generally be activated based on the location of the vehicle relative to other known or previously defined locations. For example, the present disclosure illustrates the system and method for generating the selectable option for park assist and valet mode, both of which are activated when approaching specific locations (e.g., parking structure, office building, or restaurant). Park assist is an available vehicle feature that activates the vehicle system to automatically assist drivers in parking their vehicles. That is, the vehicle can steer itself into a parking space, whether parallel or perpendicular parking, with little to no input from the user. The valet mode or option is a similar feature that is activated near specific locations, such as hotels, restaurants, bars, etc., that include valet services. Activation of the vehicle system for the valet mode option may lock components of the vehicle (e.g., the user interface device, glove box, vehicle trunk) so that the valet driver cannot access private information that may be stored within the vehicle. The valet option may be triggered upon realization by the controller 110 that the vehicle is approaching an establishment with a valet service. This may be known by stored data relating to an establishment within the external data store 335.

The location-based options may be associated with a normalized usage frequency to indicate the number of times a selectable option has been activated at a particular location. The normalized usage frequency may be determined by the controller 110. The value of the normalized usage frequency (F_{AF}(i,j)) may be obtained using a two tier implementation. Initially, when the number of visits or observations is limited, a true value of the normalized frequency is generated using the first implementation. That is, before a predefined minimum number of visits to a location is met (Nₘᵢₙ), the total number of feature activations of a specific feature at a specific location is divided by the total number of visits to that location to give the true value of the number of times a feature has been activated at a location. The minimum threshold may be used in order to include a greater sample of observations of feature activations at a specific location to give a more accurate percentage. A minimum number of visits may include a value defined in the external data store 335 and may be set by the vehicle manufacture, dealer, or possibly the vehicle driver.

The true usage mode, or a percentage of how often a feature is used at a specific location, may give the actual number of times a feature has been used at a specific location. N(i,j)ₐ represents the number of feature activations at a specific location, e.g., the number of times a feature such as park assist has been used at a location such as the supermarket. For example, i is the location and j may be the feature. N(i)ₐₗₗ represents the total number of visits to location i. The true value may be calculated using the following formula: F_{AF}(i,j)=N(i,j)ₐ/N(i))ₐₗₗ.

If the total number of visits to a specific location has met or surpassed the predefined minimum, the process follows the second implementation. The second implementation involves a recursive formula which may be used to estimate the normalized usage frequency (F_{AF}(i,j)) online without the need for specific data points such as the number of feature activations at a specific location. The second implementation includes a learning rate which may reflect memory depth of the external data store 335, and a reinforcement signal that may progressively become stronger the more times a feature is activated at a location. The normalized usage frequency for the online mode may be calculated using the following formula: F_{AF}(i,j)=(1−α)*F_{AF}(i,j−1)+(α)* Sig_{reinforce}(i,j), where α=the learning rate (e.g., on a scale of 0 to 1, where 1 represents a significant learning rate), F_{AF}(i,j)=the normalized usage frequency of feature j at location i as explained above, and Sig_{reinforce}(i,j)=the reinforcement signal representing feature j being activated at location i (e.g., on a scale of 0 to 1, where 1 represents a strong reinforcement signal).

Switching to the recursive second formula helps address two issues. First, the formula reduces the amount of memory used because the second formula does not require N(i)ₐₗₗ or N(i,j)ₐ to estimate the normalized usage frequency. This may not only free up memory space, but also provide for faster processing time Likewise, the online mode may generate a more reliable output because a minimum threshold of activations at a particular location has been met, indicating the driver's preference to use a particular feature often at a specific location. Further, the second formula reflects the most recent driving usage in case the driver's preference shifts. The value of the learning rate (α) can be modified to reflect the most recent interactions of the driver and a specific feature at different locations.

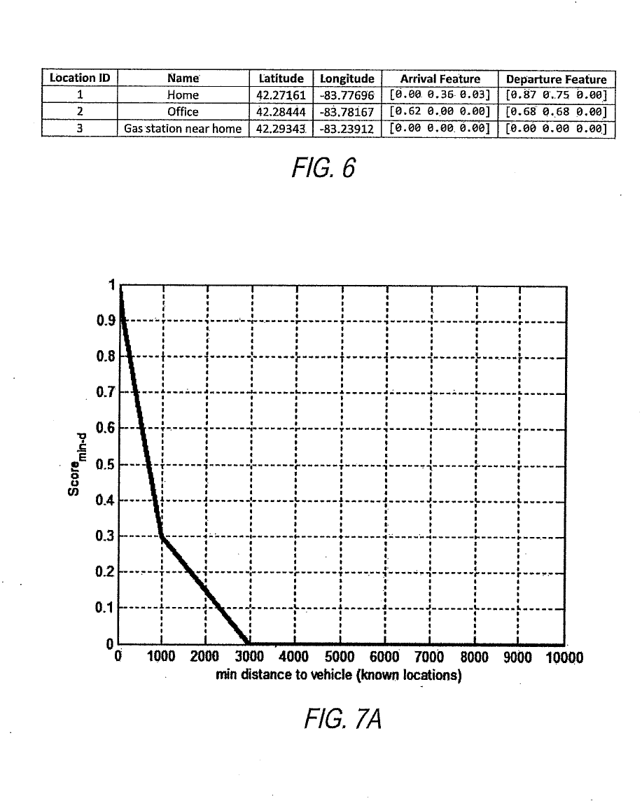

With reference to FIG. 6, the location-based options (e.g., park assist, valet mode, garage door control, etc.) may be activated when the vehicle approaches or leaves a specific location. In general, each specific location may have a record associated with the location within the external data store 335. The external data store 335 may include the latitude and longitude positions for a specific location (e.g., home, office, restaurant by office, etc.). Each record associated with a location may further include a field representing a normalized usage frequency relevant to specific features at the applicable location. Additionally or alternatively, each record may be saved in one or both of an arrival group and a departure group, thus creating two records associated with a location. By doing so, features associated with the start of a drive cycle and those associated with the end of a drive cycle may be differentiated thus providing more accurate and timely predictions in terms of each feature's usefulness to the driver.

Each element within the field represents the normalized usage frequency of a specific feature (e.g., cruise control, garage door control, house alarm activation, park assist, valet mode, cabin temperature, etc.). For example, in the arrival group record for Home, the field may contain the normalized usage frequency for cruise control, park assist, and cabin temperature, among others. If the feature (or selectable option) has never been activated at a specific location, the normalized usage frequency may be low, or possibly may not register in the field. For example, the selectable option for cruise control may register a normalized usage frequency of 0.00 at the Home location. On the other hand, the selectable option for garage door control within that field may register a higher normalized usage frequency depending on the number of selectable option activations or the learning rate for the selectable option. The normalized usage frequency for each feature may be constantly adjusted or updated to reflect the driver's or passengers' preferences.

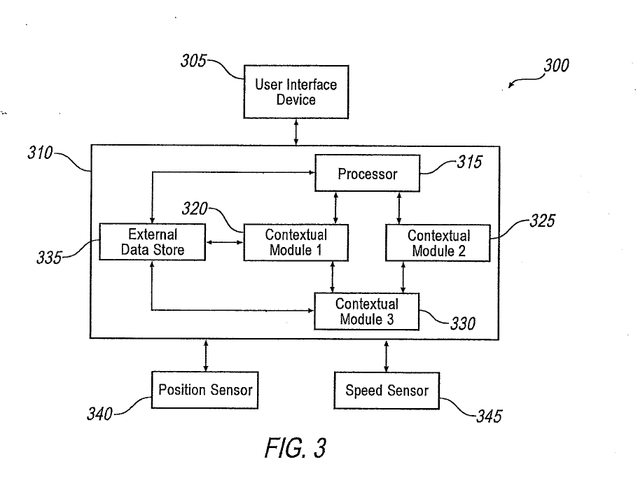

FIG. 3 illustrates an embodiment of the system 300 for the generating feature score for a selectable option. The system may include a user interface device 305, a controller 310 having a processor 315, contextual modules 320, 325, and 330, and a plurality of sensors 340, 345 communicating input to the controller 310. The variables produced by basic sensors 340, 345 and contextual modules 320, 325, and 330 are all communicated to the processor 315 to produce a feature score associated with a selectable option. The feature score may be used to determine the most relevant selectable option in relation to the driving context. The system 300 may further include location data stored in an external data store 335 which may contain, for example, previous vehicle stop locations, the number of park assist and valet mode feature activations per previous stop location, and user points-of-interest (POIs). The location data may be updated in the external data store after a certain period in time. For example, the external data store 335 may only save the previous vehicle stop locations from the past 30, 60, or 90 days. This may help reflect the driver's most current driving preferences, and may also decrease the amount of memory used by the location data.

In one embodiment, the system 300 may generate the selectable option for park assist. As explained, a position sensor 340 and a speed sensor 345 may be in communication with the controller via an interface. The vehicle speed sensor 345 may include a speedometer, a transmission/gear sensor, or a wheel or axle sensor that monitors the wheel or axle rotation. The vehicle position sensor 340 may include a global positioning system (GPS) capable of identifying the location of the vehicle, as well as a radio-frequency identification (RFID) that uses radio-frequency electromagnetic fields, or cellular phone or personal digital assistant (PDA) GPS that is transmitted via a cellphone or PDA by Bluetooth®, for example.

Each of the contextual modules 320, 325, 330 may perform a specific function within the controller 310. While each of their respective functions are described herein, these are merely exemplary and a single module may perform all or some of the functions. The third contextual module 330 may be configured to receive the vehicle's position from the vehicle position sensor 340 and the vehicle's previous stop locations from the external data store 335. Based on these sensor inputs, the third module 330 may determine a stop location (e.g., an establishment) located within a close proximity to the vehicle's current location.

The first contextual module 320 may be configured to obtain this stop location from the third contextual module 330. It may also determine how many times a specific feature has been used at this location. For example, the first module 320 may determine how many times park assist has been used at the establishment. This information may be available in a location record within the external data store 335 and may be used to determine the normalized usage frequency for the specific location (using either the true usage mode or the online usage mode formula), as described above. For example, the park assist usage per location may be input as N(i,j)ₐ and the number of visits to the closest previous stop locations may be input as N(i)ₐₗₗ for the true usage formula. On the other hand, all that may need to be input to the first contextual module 320 for the online usage mode may be the previous stop location, and a normalized usage frequency will be generated for the available selectable options. The first contextual module 320 may be configured to output the normalized usage frequency to the processor 315 to be used as input for generating a feature score for a selectable option, may be configured to output the normalized usage frequency to the external data store 335 in order to update the record of specific locations, or both.

The second contextual module 325 may be configured to obtain the vehicle's position communicated from vehicle position sensor 340 and the closest vehicle stop location communicated from the third contextual module 330 to determine the distance to the closest location. In an exemplary approach, the vehicle speed sensor 345 may be communicated directly to the processor 315. The outputs produced by the first and second contextual modules 320 and 325, and the vehicle's speed communicated by the vehicle speed sensor 345 may then be communicated to the processor 315 to attribute the values to the selectable option for park assist. The processor 315 may then generate a feature score associated with the park assist selectable option based on the variables received and display the park assist selectable option to the user interface device 305 for driver interaction.

Additionally or alternatively, the system 300 may produce a selectable option for a valet option/mode. Much of the system 300 is similar to the selectable option for park assist, except for the addition of valet Points-of-Interest (POIs). The valet POIs provide information regarding whether valet services are offered at a specific location or establishment. The valet POIs may be available either through an on-board map database saved as location data into the external data store 335 or in the form of a network service (e.g., cloud-based communication). The valet POIs may be obtained directly from the external data store 335 (e.g., the external data store 335 is programmed with specific locations that provide valet services) or by inference through interpretation of the name of the location in the external data store 335. For example, trigger words such as conference center, hotel, or restaurant may indicate that valet services are typically provided at such locations. If the valet POIs of a location are not already stored in the external data store 335, or the name of the location does not give rise to inference by interpretation, then activation of the valet mode selectable option at a particular location may be updated to the external data store 335 to associate that location with providing valet services. The valet POIs may influence the feature score for the valet mode selectable option because, if a 1location does not offer valet services, the particular feature may lose its relevance (and consequently generate a low feature score).

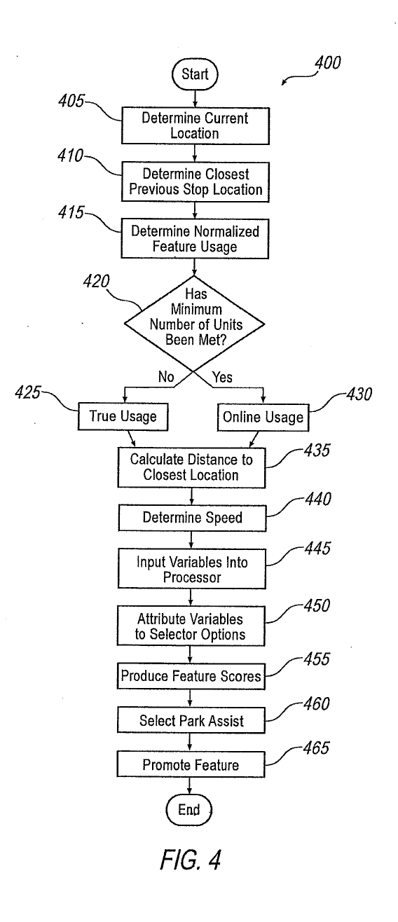

FIG. 4 represents a process 400 for generating a feature score associated with a selectable option. For exemplary purposes only, the forgoing explanation will refer to a park assist option. Initially, the current vehicle location may be determined at block 405. This may be accomplished by the vehicle position sensor 340. The information obtained by the vehicle position sensor 340 may be communicated directly to the third contextual module 330 at block 410. The third contextual module 330 compares the current position with the previous stop locations within the data store 335 to determine a closest previous stop location. For instance, the vehicle's current position output by the vehicle position sensor 340 and the previous stop locations communicated by the external data store 335 may be aggregated in the third contextual module 330 to produce the closest previous stop location (e.g., the vehicle's current position relative to pervious stop locations stored within the external data store 335).

At block 415, the third contextual module 330 may communicate the closest previous stop location to the first contextual module 320. The first contextual module may then retrieve data associated with the closest previous stop location from the data store 335. This information may include a use indicator indicating the number of times a specific feature, e.g., the park assist, has been used at this location. This, in turn, may be used by the first contextual module 320 to calculate the normalized usage frequency, as described above. For example, the first contextual module 320 may also receive the number of selectable option (or feature) activations at the specific location from the external data store 335. The external data store 335 may indicate that the park assist selectable option has been activated seven times at the supermarket near the driver's home. If the total number of visits to the closest previous stop location has not reached the predefined minimum number of visits (e.g., N(i)ₐₗₗ≦Nₘᵢₙ), then the true usage mode (at block 425) will generate a contextual variable indicating the true usage frequency of using park assist at the specific location. On the other hand, after the minimum number of visits has been met (e.g., N(i)ₐₗₗ>Nₘᵢₙ), the online mode (block 430) will generate a smart contextual variable that estimates the normalized usage frequency of a feature at a particular location. Depending on the value provided by the Signal Reinforcement (Sig_{reinforce}(i,j)) and the learning rate (α), the contextual variable generated by the first contextual module 320 may either be strong (e.g., close to 1) or weak.

At block 435, the second contextual module 325 may receive input from the vehicle position sensor 340 and the closest stop location from the third contextual module 330 to calculate the distance between the current vehicle position and the previous stop location. The closer the vehicle is to the closest previous stop location, the greater the value of the smart contextual variable. Further, at block 440 the vehicle speed sensor 345 determines the vehicle's current speed. The simple contextual variable output by the vehicle speed sensor 345 is inversely proportional to the vehicle's speed. For example, if the vehicle is traveling at a rate of 40 mph, the likelihood that the vehicle is going to stop (and thus likelihood of using park assist) is low.

At block 445, the contextual variables output by first contextual module 320, the second contextual module 325, and the vehicle speed sensor 345 may be communicated to the processor 315. The processor 315 attributes values received to the selectable options at block 450. As previously mentioned, if the selectable options are categorized into an arrival group and a departure group, then the contextual variables may only need to be input into the arrival group selectable options. This can be determined if the vehicle has been key on and driver for certain amount of time and distance. The variables may be aggregated to produce a feature score (block 455). The heuristics employed in aggregating the values may be achieved in various ways, including, but not limited to, taking the product, average, maximum or minimum of the values. At block 455, the processor 315 may take the product of the variables output by the first contextual module 320, the second contextual module 325, and the vehicle speed sensor 345 to generate the feature score for the selectable options.

At block 460, the processor 315 may select the park assist selectable option if the feature score is the highest relative to the other available selectable options. The processor 315 may promote the feature to be displayed on the user interface device 305 at block 465. At the same time, the processor may eliminate a feature already present on the user interface device 305 that may not be of relevance in the current context.

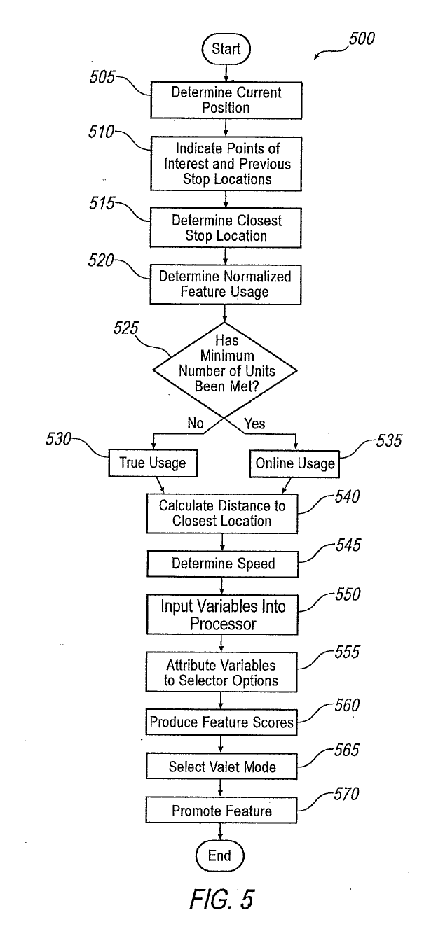

FIG. 5 illustrates a flow chart using an exemplary process 500 for generating the valet mode selectable option and promoting the selectable option to the user interface device 305. The current vehicle location may be determined at block 505 by way of a vehicle position sensor 340. At block 510, the external data store 335 may indicate the previous stop locations and valet POI to determine the relative location data based on the vehicle's current position. The external data store 335 may communicate the location data to the third contextual module 330. At block 515, the third contextual module 330 may combine the location data received by the external data store 335 with the vehicle's position output by the vehicle position sensor 340 to determine the closest previous stop location that offers valet services. As previously mentioned, the valet POIs may be obtained directly from the external data store 335, or the POIs may be inferred by reference to the name of the location (e.g., Restaurant, Movie Theater, Conference Hall).

At block 520, the closest previous stop location may then be communicated to the first contextual module 320 in order to determine the normalized usage frequency of valet mode at the particular location. For example, if the closest previous stop location is the restaurant by the driver's office, that will be input as (i) and the valet mode as (j) in the normalized usage frequency formula described above. If the minimum number of visits before switching to the online mode has not surpassed the total number of visits (e.g., N(i)ₐₗₗ≦Nₘᵢₙ), then the true usage frequency will be calculated at block 530. If, on the other hand, the amount of visits to location (i) has met the predefined minimum, the online usage frequency may be calculated using the recursive formula at block 535. Regardless of the formula used, a smart contextual variable for normalized feature usage for valet mode will be output from the first contextual module 320. If the normalized usage of valet mode selectable option is high, the likelihood of the feature being activated is high, and thus the value associated with the smart contextual variable produced is high.

At block 545, the second contextual module 325 may receive the vehicle's position from the vehicle position sensor 340 and the closest previous stop location from the third contextual module 330 to determine the distance to the closest previous stop location. If the distance to the closest previous stop location that provides a valet service is small, the likelihood of the valet mode feature being selected is high (and again, the value of the smart contextual variable output is high). Additionally, the vehicle's speed is determined at block 545 by the vehicle speed sensor 345. If the vehicle's speed is low, the likelihood that the vehicle is going to stop in the near future is high.

At block 550, the vehicle's speed, the normalized usage frequency, and the distance to the closest location are input into the processor 315. The processor 315 may attribute the values to the available selectable options at block 555. The processor 315 may then produce a feature score for each selectable option by aggregating the values received at block 555. The processor 315 may additionally prioritize the selectable options that have surpassed a minimum threshold. The selectable option with the highest feature score may be assigned the highest priority, the selectable option with the second highest feature score may be assigned the second highest priority, and so on and so forth. If the feature score for the valet mode selectable option was attributed the highest feature score, and thus has been assigned the highest feature priority, the processor 315 may select valet mode at block 565 and promote it for display on the user interface device 305 at block 570. Alternatively, the processor 315 may select multiple selectable options having the first, second, etc. priority for promotion to the user interface device 305. The processor 315 may accordingly demote a selectable option that has a lower feature score relative to the driving context, such that the selectable option with the highest feature score is always displayed on the user interface device 305.

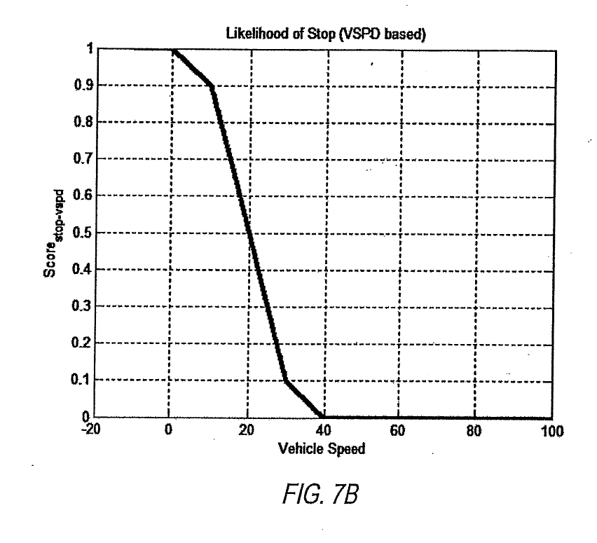

With reference to FIGS. 7A and 7B, the feature score associated with the various stop-location based selectable options (e.g., park assist or valet mode) may be based on at least three If/Then rules. If the normalized usage frequency of park assist or valet mode output by the first contextual module 320 is high, the likelihood (and thus the value of the contextual variable output) of the associated selectable option may also be high. FIG. 7A shows relative features scores based on the distance of a vehicle from a known location. As shown in FIG. 7A, if the distance to a known location (produced by the second contextual module 325) is small (e.g., less than 500 meters), then the likelihood that the vehicle is going to stop at the location is high. FIG. 7B shows relative feature scores based on the speed of a vehicle. As shown in FIG. 7B, if the vehicle speed (as determined by the vehicle speed sensor 345) is low, the likelihood of that the vehicle is going to stop at the location is high. The processor 315 aggregates these values to determine a feature score. Thus, a synergy between the three values may be required to generate a high feature score.

In one example, if the distance to the closest previous stop location is small and the normalized usage frequency is high, but the vehicle is traveling 45 mph, it may be unlikely that the vehicle is going to stop at the location. Therefore, the feature score for park assist or valet mode, for example, may be low and thus, the user interface may not display such options. Similarly, if the vehicle is close to a previous stop location and the vehicle is traveling at a slow rate, but the specific feature has never been activated at the location, a relatively low normalized usage frequency may be realized and the likelihood of interacting with that feature (e.g., the feature score) will also be low.

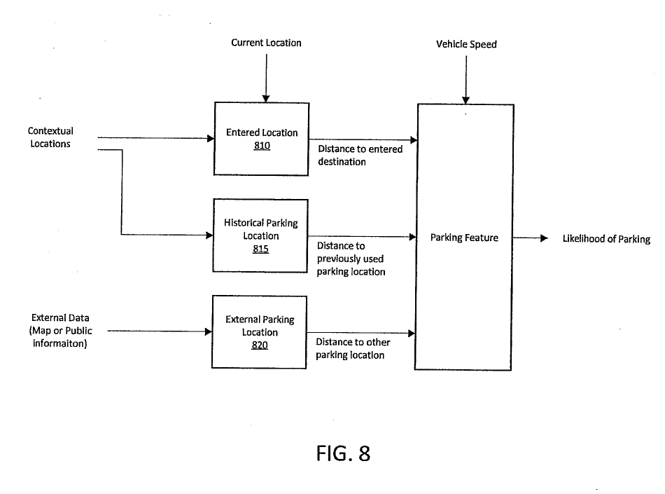

FIG. 8 is an exemplary block diagram for generating a feature score for a parking feature. The block diagram is exemplary and meant to show how an end location 810, historical location 815, and an external parking location 820, may be used to evaluate a parking feature at the interface system 100. The entered location 810 may be entered by a user via the navigation system.

The historical parking location 815 may be a location having a parking feature that has routinely been selected at that location. For example, a driver may routinely parallel park using the Park Assist feature when he or she visits the bank. Each time a feature is used at a given location, a use indicator associated with that given location may be positively incremented within end location data in data store 130. Additionally, if a feature is not selected at a given location, the use indicator may be negatively incremented. The use indicator may be associated with a specific end location such as an address. However, it may also be associated with a geographical location in general (e.g., geographical coordinates). That is, the parking location 815 may be associated with an end location address (e.g., the bank's address) and/or the parking location may be the geographical location of the parking place (e.g., the geographical coordinates of the parking lot in front of the bank.) The use of a low pass filter may be used to increment/decrement the use indicator. For example, a vector of frequencies is associated with a list of the driver's frequent locations. When a driver is observed to have visited a location, the value in the vector of frequencies associated with that location will be increased using a low pass filter with the reinforcement signal value assigned to one while the rest of the values in the vector decrease with their reinforcement signals assigned to be zero. In this example, because the reinforcement signals are either one or zero and content in the vector of frequencies will be between 0 and 1 indicative of the driver's preference of trip destinations. Further, the use indicator may be maintained elsewhere besides the data store 130. Thus, the end location may be a predicted location based upon a user/vehicle's historic behavior.

As explained, the external parking location 820 may be a parking location (e.g., structure or lot) near a certain location (e.g., stadium, restaurant, etc.) This information may be supplied from the data store 130, or from external sources such as a map or public database. Additionally, multiple entered locations 810, historical locations 815 and external locations 820 may be received and identified by the contextual module 120, 125. Before a location is remembered, the driver may be requested to approve the location as a remembered location. That is, before the location is as a preferred or remembered location, the driver may be required to consent to such. Similarly, the driver may remove the location and data associated therewith. Thus, the driver may remove locations that are no longer of interest.

As a vehicle moves along a route, the current location (i.e., a contextual variable) as acquired by the contextual module 120, 125 in on example by the GPS, may be compared to one or all of the predicted end locations periodically or as needed. The distance between the predicted end locations and the current location may be determined by the contextual module 120. Once the distance is calculated, the closest location out of the predicted end locations (e.g., the entered location 210, the historical parking location 815 and the external parking location 820 may be selected) may be selected by as the end location. In some configurations, an entered location may be by default the end location and the contextual module 120, 125 may not calculate the distance between the current location and end location. However, in some configurations, while the end location may be specifically entered into the navigations system by the user, a parking lot or structure may be a more appropriate end location and thus the distance may still be calculated to determine the end location. For example, although a user had entered the address to a restaurant, as the vehicle approaches the restaurant, the vehicle may pass the parking lot for the restaurant. In this situation, the end location may be the parking lot and not the address of the restaurant.

As explained, when multiple predicted end locations are possible, these locations may be aggregated and compared to determine which is closest to the current location. Once the end location is selected, the contextual module 120, 125 may receive a simple contextual variable from the basic sensors 135, 140, such as the vehicle speed. The processor 115 may assign a score to the current driving context based on the vehicle speed, location with respect to the select location, and the use increment associated with the selected location. For example, if the vehicle is traveling at a slow speed and close to a location that the vehicle routinely parks at, the parking feature may receive a high feature score, thus placing it as a selectable option on the interface device 105. On the other hand, if the vehicle is traveling at a slow speed, but is nowhere near the end location or a historic parking location, then the feature score may be low.

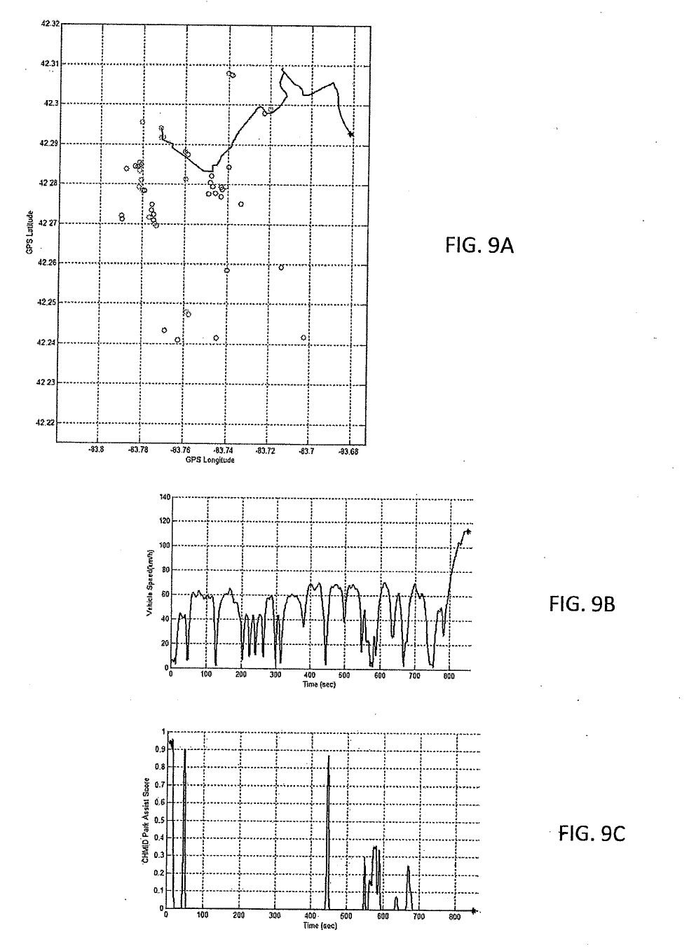

FIGS. 9A-C are exemplary data charts indicative of contextual variables for generating feature scores for the interface system. In FIG. 9A, an exemplary location data chart is shown. The location data chart may indicate via latitudinal and longitudinal coordinates, the route of a vehicle, indicated by the solid line in the figure. Further, various end locations may be represented by the circles in the figure. In FIG. 9B, the vehicle speed may be graphically represented with respect to time. Based on the vehicle's location with respect to a known end location, and given the vehicle's speed, the controller 110 may assign a feature score for the driving context. Exemplary feature scores are shown in FIG. 9C. As shown in the figure, at approximately 50 seconds, the feature score is approximately 0.9. At approximately 450 seconds, the feature score is approximately 0.85. These high feature scores correlate with the vehicle location being very close to a known end location, as well as a very low vehicle speed. On the other hand, between 50 seconds and 450 seconds, the feature score may be low because the vehicle is not approaching or close to any end locations, regardless of the speed of the vehicle. Moreover, between approximately 550 seconds and 675 seconds, the feature score may increase up to 0.35. At these instances, the vehicle's speed may decrease, but the current vehicle location may be far from any known end locations.

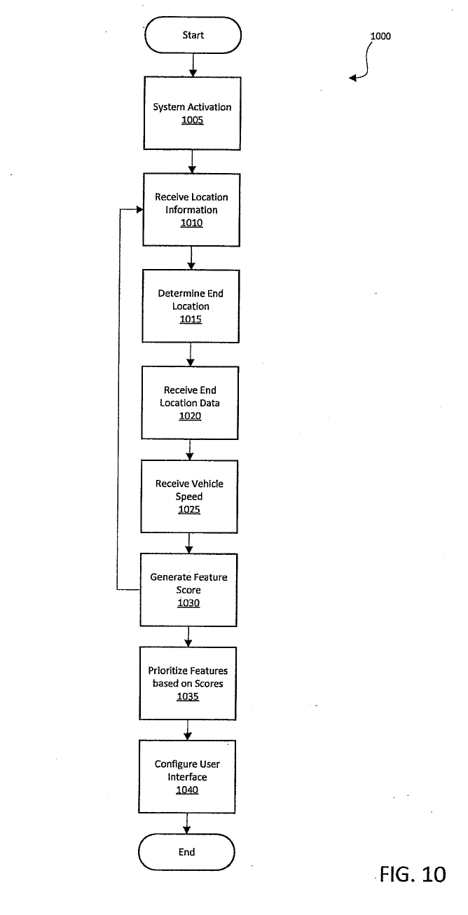

FIG. 10 is a flow chart for implementing an exemplary interface system process 400. The process 1000 may begin at block 1005 where the operation of the user interface system 100 may activate automatically no later than when the vehicle's ignition is started. At this point, the vehicle may go through an internal system check in which the operational status of one or more vehicle systems and/or subsystems will be determined in order to ensure that the vehicle is ready for operation. While the internal system check is being verified, the system 100 may additionally determine the vehicle's current location. Once the system is activated, the process may proceed to block 1010.

At block 1010, the contextual module 120, 125, may receive location information (i.e. simple contextual variable) from one of the contextual modules 120, 125. The location information, as explained above, may include one or more predicted end locations. These end locations may be included based on either user entered information (e.g., entering an address into the navigation system), or predicted based on the historical behavior of the user/vehicle. The received location information may include a list of predicted end locations when the end locations are predicted. For example, the end location may include several historical parking locations which the contextual module 120, 125 may include in the location information based on the route the vehicle is currently taking. Once the location information is received, the process 400 may proceed to block 100015.

At block 1015, the contextual module 120, 125 may determine an end location (i.e. smart contextual variable) from the predicted end locations. Depending on the configuration, the processor 115 may determine the end location based on a defined hierarchy, for example, always selecting a user entered location over a predicted location, as well as by aggregating the predicted end locations and selecting the potential location that is closest to the vehicle's currently location. The latter configuration may require that the processor 115 receive the current location of the vehicle from the basic sensor 135, 140. One of the contextual modules 120, 125 within the processor 115 may determine the distance between the current location and each predicted end location. Based on these distances, the location within the nearest proximity of the current location may be selected as the end location. As explained, this analysis may not be necessary if the user had entered an end location via the navigation system at the interface device 105. Once an end location is determined, the process 1000 proceeds to block 1020.

At block 1020, the contextual module 120, 125 may receive end location data including a use indicator (i.e. smart contextual variable) associated with the end location. This data may be retrieved from the data store 130 or another external source. The use indicator may indicate how often the feature is used at the end location. The process 1000 proceeds to block 1025.

At block 1025, the contextual module 120, 125 may receive the current vehicle speed (i.e. simple contextual variable) from the basic sensor 135, 140. The contextual modules 120, 125 may receive the speed and in turn output it to the processor 115. The process 1000 may proceed to block 1030.

At block 1030, the contextual variables, including the end location, end location data and vehicle speed, may be communicated to the processor 115 to generate a feature score. The processor 115 may combine the received contextual variables and associate values to the feature or features. The feature scores may be generated by aggregating the contextual variables by taking the product, average, maximum, minimum, or other non-linear algorithms such as Fuzzy Logic or neural networks, for example. The feature score may be directly proportional to the relevance of the aggregation of the contextual variables communicated to the processor 115. For example, if the vehicle is in close proximity to its end location where it typically uses the Park Assist feature, the feature score for the selectable option associated with the Park Assist feature will have a higher value than if the vehicle was not in close proximity to the end location and traveling at a high speed. The process 1000 proceeds to block 1045.

At block 1045, the processor 115 may prioritize the selectable options based on their associated feature scores. Generally, the selectable options with the highest feature score may have the highest priority, and the rest of the available selectable options are ranked accordingly thereon. Depending on the user preference, either the feature with the highest feature score, or multiple features (e.g., the three features with the highest feature scores), may be promoted to the user interface device 105 at block 1040 for display and performance Likewise, the features already displayed on the user interface device 105 may be simultaneously eliminated (or demoted) if their relevance within the particular driving context has decreased. Additionally or alternatively, the processor 115 or controller 110 may order the selectable options according to the feature score associated with each selectable option. The controller 110 may then determine the order of the selectable options with features scores above a predetermined threshold. For example, the controller 110 may only select the selectable options with a feature score at or above 0.7. The controller 110 m ay then rank the available selectable options with the highest feature score to a first position, another selectable option with a slightly lower feature score to a second position in the order, and so on.

In one example, the parking feature may be promoted and displayed on the interface device 105 when a high likelihood that the user is going to park the vehicle is determined. This may be based in part on the proximity to the end location, the frequency that the feature has been used at the end location previously, and the current speed of the vehicle. The parking feature, as explained, may include a Park Assist feature which may be used to parallel park a vehicle. The parking feature may also include a general parking aid/feature in which the view from the rear-view cameras is displayed on the interface device 105, or another screen visible to the user, to aid the user is parking the vehicle. Each of the Park Assist feature and the general parking feature may be evaluated and scored independent of each other. Thus, one selectable option associated with one of the parking features may be displayed on the interface device 105 while another is not. However, is some driving contexts, both selectable options may be displayed.

As shown, blocks 1010-1030 may perform a continuous cycle while the vehicle is in operation. The basic sensors 135, 140 and contextual modules 120, 125 are active at all times, continually inputting information into the processor 115 which continuously generates new feature scores associated with available selectable options (e.g., the ones associated with the parking features) so that the most relevant features may be available and presented via the interface device 105.

Accordingly, an interface system for determining the likelihood that a vehicle feature will be selected by a driver, and displaying that feature on the interface accordingly, is described herein. By contextually evaluating the selectable features, the interface may be more user-friendly, increase the frequency of use of various features due to displaying the selectable features at time of likely use. Further, the system may provide for a safer, less distracting, driving experience.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, the use of the words “first,” “second,” etc. may be interchangeable.

What is claimed is:

1. A vehicle interface system comprising:
an interface configured to present icons representing selectable vehicle features; and
a controller programmed to
generate a score for each of the features based on a contextual variable including one or all of a vehicle location, vehicle speed and a predicted end location for the vehicle, and
display certain of the icons and hide other of the icons based on the generated scores.

2. The system of claim 1, wherein the controller is further programmed to generate the score based a distance between the vehicle location and the predicted end location.

3. The system of claim 2, wherein the score increases as the distance decreases.

4. The system of claim 1, wherein the score increases as the vehicle speed decreases.

5. The system of claim 1, wherein the predicted end location is defined by a user, identified based on previous driving behavior, or identified based on parking location data.

6. The system of claim 1, wherein the at least one contextual variable includes end location data including a use indicator indicative of a historical use of the vehicle feature, the controller configured to generate the score based at least in part on the use indicator of the vehicle feature.

7. The system of claim 1, wherein the feature includes a park assist feature configured to facilitate parallel parking of the vehicle.

8. The system of claim 1, wherein the score represents the likelihood that each icon will be selected via the interface.

9. A vehicle controller, comprising:
at least one contextual module configured to generate at least one contextual variable representing a driving context including vehicle location or vehicle speed; and a processor programmed to
generate a feature score based on one or both of a vehicle location and vehicle speed as defined by the at least one contextual variable, wherein the feature score representing the likelihood that a vehicle feature will be selected via an icons associated with the vehicle feature based on the driving context, and
display certain of the icon and hide other of the icons based on the feature scores.

10. The controller of claim 9, wherein the at least one contextual variable includes an end location, the processor configured to generate the feature score based at least in part on a distance between the vehicle location and the end location.

11. The controller of claim 11, wherein the end location is defined by a user, identified based on previous driving behavior, or identified based on parking location data.

12. The controller of claim 9, wherein the at least one contextual variable includes at least one end location data including a use indicator indicative of a historical use of the vehicle feature, the processor further programed to generate the feature score based on the use indicator of the icon.

13. The controller of claim 12, wherein at least one contextual variable includes a vehicle speed indicator, the processor further programmed to generate the feature score based on the vehicle speed indicator.

14. The controller of claim 9, wherein the icon is associated with the vehicle feature and presented via an interface device to interact with a system associated with the vehicle feature, the vehicle feature including at least one of a park assist feature configured to facilitate parallel parking of the vehicle.

15. A method comprising:
receiving at least one contextual variable from a contextual module;
generating a feature score based on the at least one contextual variable; and
displaying an icon associated with a vehicle feature, based on the feature score to an interface device, the icon configured to interact with a system associated with the corresponding vehicle feature.

16. The method of claim 15, wherein the displaying of the icon is based on comparing the feature score with other feature scores of other icons and ordering the icons based on each feature score associated therewith, the ordering of the icons resulting in displaying certain of the icons on a user interface and hiding other of the icons.

17. The method of claim 15, further comprising receiving additional contextual variables and continually updating the feature score and the ordering of the icons as the additional contextual variables are received.

18. The method of claim 15, wherein the at least one contextual variable includes a current location and an end location, the feature score generated based on a distance between the current location and the end location.

19. The method of claim 18, wherein the end location is defined by a user, identified based on previous driving behavior, or identified based on parking location data.

20. The method of claim 19, wherein the at least one contextual variable includes at least one end location data including a use indicator indicative of a historical use of the icon, the feature score generated based on the use indicator of the icon.
